(19) United States
(12) Patent Application Publication
(10) Pub. No.: US 2024/0354533 A1
(43) Pub. Date: Oct. 24, 2024

(54) PRINTER REFERENCING ALLOCATION INFORMATION TO IDENTIFY TARGET FONT FILE FOR DRAWING IMAGE OF CHARACTER

(71) Applicant: BROTHER KOGYO KABUSHIKI KAISHA, Nagoya (JP)

(72) Inventor: Kenshiro NAKAJIMA, Kani (JP)

(21) Appl. No.: 18/636,664

(22) Filed: Apr. 16, 2024

(30) Foreign Application Priority Data
Apr. 20, 2023 (JP) 2023-069343

(51) Int. Cl. G06K 15/02; G06F 16/14

(52) U.S. Cl. CPC G06K 15/1827; G06F 16/14; G06K 15/1848; G06K 15/1888

(57) ABSTRACT

A printer includes a memory, a print engine, and a controller. The controller performs a first acquisition process to acquire print data specifying a character, and a second acquisition process to acquire specific information from the print data. The specific information specifies a font. The controller performs an identification process to identify a target font file, using the piece of allocation information stored in the memory, from among the plurality of font files. The piece of allocation information is for associating the specific information with the target font file. The identification process references the piece of allocation information to identify the target font file associated with the specific information acquired in the second acquisition process. The controller performs a drawing process to draw an image of the character using the target font file to generate image data to be used in printing by the print engine.

### REFERENCE TO RELATED APPLICATIONS

This application claims priority from Japanese Patent Application No. 2023-069343 filed on Apr. 20, 2023. The entire content of the priority application is incorporated herein by reference.

### BACKGROUND ART

Some conventional printers perform printing on the basis of print data described in a page description language, using font information of built-in fonts stored on the printer in advance.

### SUMMARY

In order to draw text in a font specified by print data, a printer must identify a font file corresponding to the specified font. When the procedure for identifying this font file would become too complicated, the processing of print data will be delayed. The conventional technology does not describe a process by which the printer identifies the font file corresponding to the specified font and therefore has room for improvement.

In order to attain the above and other object, the present disclosure provides a printer. The printer includes a memory, a print engine, and a controller. The controller is configured to acquire print data specifying a character. The controller is configured to acquire specific information from the print data, the specific information specifying a font. The controller is configured to identify a target font file, using the piece of allocation information stored in the memory, from among the plurality of font files. The controller is configured to draw an image of the character using the target font file to generate image data to be used in printing by the print engine.

In the above structure, the font file associated with the font that is specified in the print data can be easily identified.

### BRIEF DESCRIPTION OF DRAWINGS

FIG. 1 is a block diagram illustrating an overview configuration of a printer.

FIG. 2 is a flowchart illustrating a DL font saving process.

FIG. 3 is an explanatory diagram illustrating a configuration of a glyph data file.

FIG. 4 is an explanatory diagram illustrating a configuration of a piece of allocation information.

FIG. 5 is an example of a font management screen.

FIG. 6 is a flowchart illustrating a printing process.

FIG. 7 is a flowchart illustrating a font identification process performed when print data is in a PDF format.

FIG. 8 is a flowchart illustrating a font identification process performed when print data is in a PCL5 format.

FIG. 9 is a flowchart illustrating a process for saving allocation information.

### DESCRIPTION

Below, a printer according to an embodiment will be described in detail while referring to the accompanying drawings. This embodiment discloses a printer capable of printing based on print data described in a page description language (PDL).

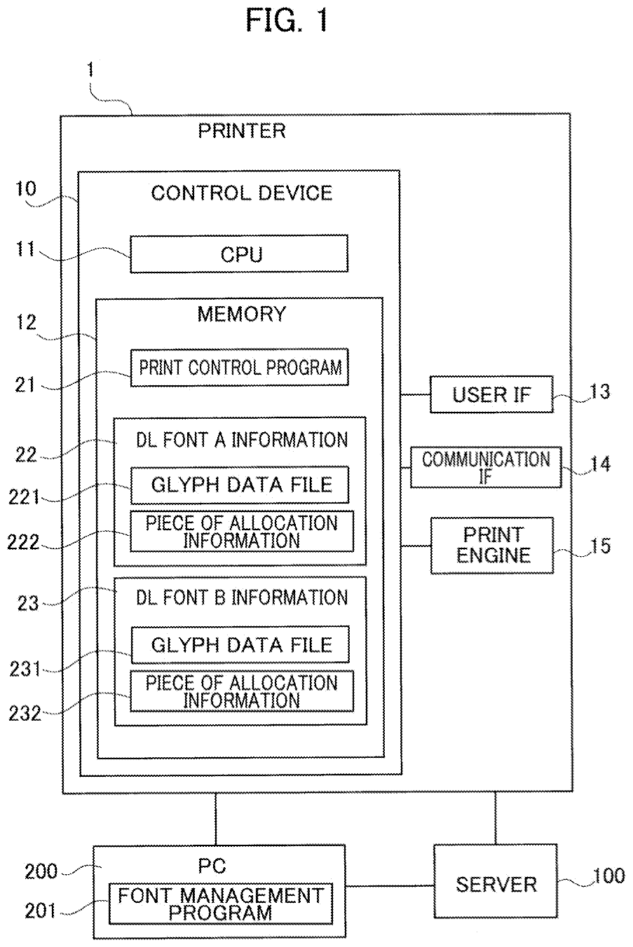

FIG. 1 shows a printer 1 according to the present embodiment. The printer 1 is provided with a control device 10 that includes a CPU 11 and a memory 12. The printer 1 is also provided with a user interface (also abbreviated as “user IF”) 13, a communication interface (also abbreviated as “communication IF”) 14, and a print engine 15. The user interface 13, the communication interface 14, and the print engine 15 are all electrically connected to the control device 10. Note that the control device 10 in FIG. 1 is a collective term that covers all hardware and software used for controlling the printer 1 and is not actually limited to representing a single piece of hardware present in the printer 1. The CPU 11 is an example of a controller. The control device 10 is another example of the controller.

The CPU 11 executes various processes, according to programs read from the memory 12 or on the basis of user operations. The memory 12 stores various programs and various data. The memory 12 is used as a work area for executing various processes. The memory 12 may include a buffer provided by the CPU 11.

An example of the memory 12 is the ROM, RAM, and HDD provided in the printer 1, and any storage medium from which the CPU 11 can read data and to which the CPU 11 can write data. A computer-readable storage medium is a non-transitory medium. In addition to the above examples, non-transitory media include CD-ROM and DVD-ROM. A non-transitory medium is also a tangible medium. On the other hand, electric signals that convey programs downloaded from a server 100 or the like on the Internet are not considered an example of the memory 12.

The user interface 13 includes hardware that displays screens for reporting information to the user, and hardware that receives operations performed by the user. The user interface 13 may include a touchscreen or a combination of a display and operation buttons.

The communication interface 14 includes hardware for communicating with an external device. The communication standard employed by the communication interface 14 may be Ethernet, Wi-Fi (U.S. trademark of Wi-Fi Alliance CORPORATION), Universal Serial Bus (USB), or the like. Alternatively, the printer 1 may be provided with a plurality of communication interfaces 14 supporting a plurality of communication standards. The communication interface 14 may be a network interface.

The print engine 15 includes a device capable of printing based on image data according to the electrophotographic or inkjet method, for example. The print engine 15 may be provided with colorants of a plurality of colors to be able to execute color printing or may be provided with colorant in a single color for monochrome printing.

The printer 1 can communicate with an external device via the communication IF 14, such as a server 100 or a personal computer (hereinafter referred to as “PC”) 200, as illustrated in FIG. 1. The server 100 or PC 200 may store font information. The font information stored in the server 100 or PC 200 is in the form of TrueType fonts, OpenType fonts, and PostScript fonts, for example. Font information includes sets of glyph data for a corresponding typeface (font type). A plurality of pieces of font information for a plurality of typefaces may be stored in the server 100 or PC 200. In this disclosure, the formats, such as, TrueType fonts, OpenType fonts, and PostScript fonts, indicate formats of files that define corresponding fonts using a plurality of sets of glyph data, and the typefaces of the fonts indicate particular styles of lettering, such as, Times New Roman, Helvetica, Arial, Mincho, and Gothic.

As shown in the example of FIG. 1, the memory 12 of the printer 1 stores a print control program 21. The print 1 further stores, as DL font information, DL font A information 22, and DL font B information 23. The DL font information of a DL font is font information downloaded from an external device such as the serer 100. That is, the DL font A information 22 and the DL font B information 23 are information on downloaded fonts (hereinafter called “DL fonts”). DL fonts are not among the fonts that are preinstalled on the printer 1. That is, DL font information is not stored in the memory 12 when the printer 1 is shipped from the factory. In addition to DL font information, the printer 1 may be provided with built-in font information that is already stored in the memory 12 when the printer 1 is shipped from the factory.

In response to user instructions, the printer 1 can acquire DL font information from an external device such as the server 100 or the PC 200 and store this information in the memory 12. Once DL font information has been stored in the memory 12, the printer 1 can use these DL fonts for printing. The user can also make these DL fonts available to the printer 1 by connecting a USB memory storing the DL font information to the printer 1, for example.

The DL font A information 22 is information on a font A, which is one DL font. The DL font A information 22 includes a glyph data file 221 for the font A, and allocation information 222. The DL font B information 23 is information on a font B, which is a DL font different from font A. For example, the typeface of the font A is different from that of the font B. DL font B information 23 includes a glyph data file 231 for the font B, and allocation information 232. This information will be described later in greater detail. The glyph data files 221 and 231 are examples of a font file.

Operations of the printer 1 will be described. Following processes are basically processes performed by the CPU 11 according to programs. The processes performed by the CPU 11 include processes that control hardware through an Application Programming Interface (API) provided in an Operating System (OS) of the printer 1. In the present disclosure, the description of the OS may be omitted when the operations of each program performed using the OS are described. Note that the term “acquire” in this specification is used as a concept that does not necessarily require a request. Further, “data” is treated as the same data even when the format (such as a text format, binary format, or flag format) is modified, provided that content of the data is essentially the same.

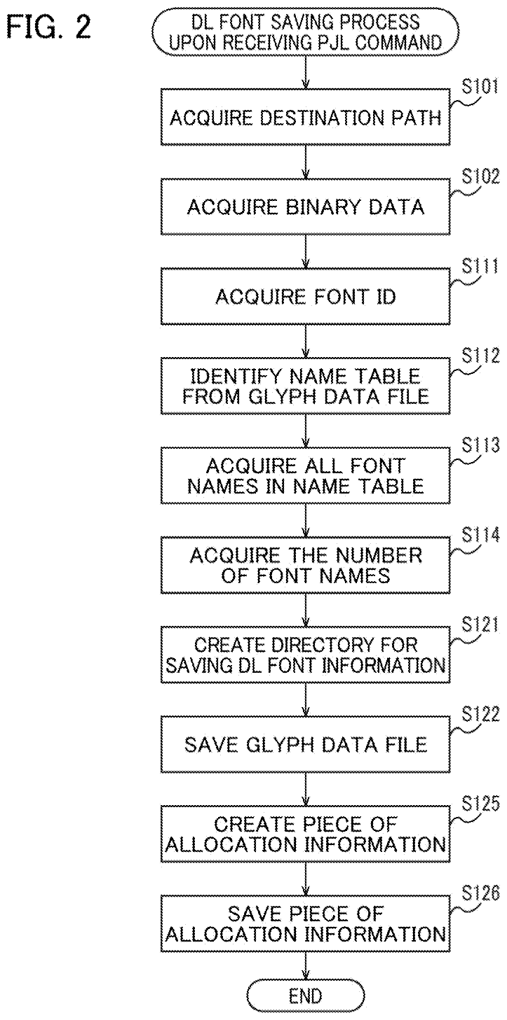

Steps in a DL font saving process will be described with reference to the flowchart in FIG. 2. The CPU 11 of the printer 1 executes the DL font saving process upon receiving a Printer Job Language (PJL) command instructing the printer 1 to save DL font information. PJL commands may be commands that direct the printer 1 to execute various processes that involve printing. However, when making instructions to save DL font information, PJL commands may be commands that direct the printer 1 to execute various processes that do not involve printing. For example, the printer 1 can receive DL font information through a prescribed PJL command sent from the PC 200.

As shown in FIG. 1, the PC 200 is provided with a font management program 201 associated with the printer 1, for example. In response to operations of a user using the font management program 201, the PC 200 can send a PJL command to the printer 1 instructing the printer 1 to save DL font information. The PJL command sent from the PC 200 includes information specifying a destination path for saving the DL font information, and binary data containing the DL font information. The method in which the PC 200 transmits PJL commands will be described later in detail.

Thus, when the printer 1 receives a PJL command instructing the printer 1 to save DL font information, in S101 the CPU 11 of the printer 1 first extracts information specifying the destination path for saving the DL font information. In S102 the CPU 11 extracts the binary data transmitted after the information on the destination path.

The binary data acquired in S102 includes a font ID, and a glyph data file in the TrueType font format. The font ID is an identification number. A different identification number is set for each DL font. The font ID is information used to identify the font to be used when printing characters based on print data in the printer command language 5 (PCL 5) format, which is a page description language developed by Hewlett-Packard (registered trademark). The printing procedure is described later.

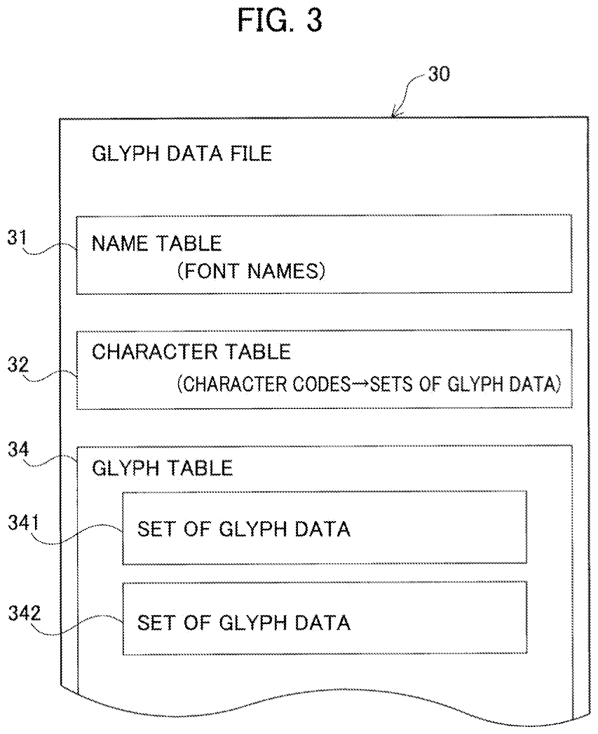

A glyph data file contains a set of glyph data for each character in the DL font. A set of glyph data is information specifying the outline of each character. FIG. 3 shows an example of a glyph data file 30 in the TrueType font format. The glyph data file 30 includes a name table 31, a character table 32, and a glyph table 34. The glyph data file 30 may further include information specifying the printing position and information specifying the character width for each character.

The name table 31 holds information specifying the font name, which is the name associated with the DL font. A font name is information used to identify a font when printing characters based on print data in the PDF format. A plurality of font names may be set for one type of font to distinguish between upper-case and lower-case letters and the inclusion or absence of symbols such as spaces or hyphens, for example. In this case, the name table 31 includes all of the plurality of names that can identify this font.

The character table 32 maps the character code for each character with the storage location of a set of glyph data for that character. The character table 32 is not limited to information represented by a single table but may be a combination of multiple tables, for example, provided that the information can associate character codes with sets of glyph data.

The glyph table 34 stores a plurality of sets of glyph data, such as sets of glyph data 341, 342, . . . , each being for a respective one of a plurality of characters. When print data includes a drawing object specifying the printing of a character, the printer 1 acquires the shape of this character using the set of glyph data for the character.

Returning to the description in FIG. 2 of the DL font saving process, in S111 the CPU 11 extracts the font ID from the acquired binary data. Note that the printer 1 does not accept the same font ID as a font ID already used in DL font information stored in the memory 12. When the font ID acquired from the received PJL command is the same number (the same value) as a font ID already stored in the memory 12, the printer 1 may report an error and end the DL font saving process, for example. In other words, the CPU 11 manages font IDs so that each font ID uniquely identifying a font in the printer 1. The process of S111 is an example of a first determination process.

In S112 the CPU 11 identifies the name table 31 from the glyph data file 30 included in the binary data. In S113 the CPU 11 then obtains all font names included in the name table 31. In S114 the CPU 11 determines the number of acquired font names. The process of S113 is an example of a first reading process.

In S121 the CPU 11 creates a directory for saving the DL font information on the basis of the information specifying the destination path that has been acquired in S101. In S122 the CPU 11 stores the acquired glyph data file 30 in the directory created in S121. Here, the CPU 11 may first process or modify the glyph data file 30 before storing the same so that the glyph data file 30 is readily available for printing. The process of S122 is an example of a storing process.

In S125 the CPU 11 creates a piece of allocation information associated with the saved glyph data file 30. The piece of allocation information serves to identify the glyph data file 30 to be used when print data specifies the use of a DL font.

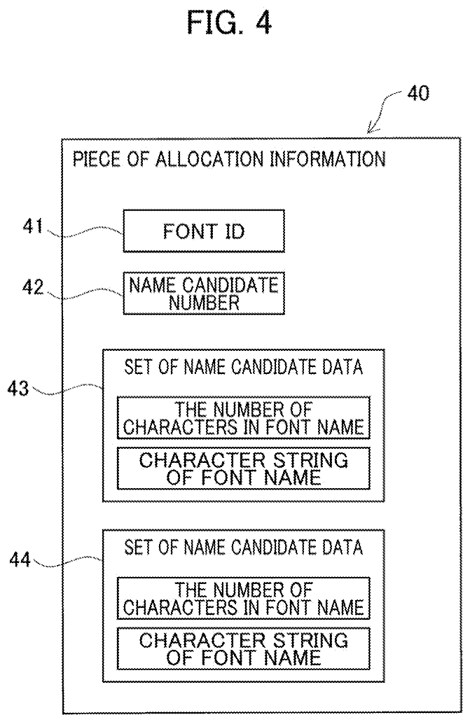

FIG. 4 shows an example of a piece of allocation information 40 corresponding to the glyph data file 30. The piece of allocation information 40 includes a font identifier (ID) 41, a name candidate number 42, and sets of name candidate data 43 and 44. The number of sets of candidate data 43 and 44 is the same as the name candidate number 42. In the example of FIG. 4, the piece of allocation information 40 has been created for the glyph data file 30 whose name table 31 contains two names. Hence, the name candidate number 42 of the piece of allocation information 40 is “2”. Further, the piece of allocation information 40 includes the set of first name candidate data 43, and the set of second name candidate data 44.

The font ID 41 included in the piece of allocation information 40 is the number (or the value) acquired in S111 of the DL font saving process. The name candidate number 42 is the number of font names identified in S114. When the name table 31 of the glyph data file 30 contains a plurality of font names, the piece of allocation information 40 includes a plurality of sets of name candidate data, each being for specifying a respective one of the plurality of font names. Further, the name candidate number 42 is 2 or greater.

The set of first name candidate data 43 included in the piece of allocation information 40 includes a character string of a font name, and the number of characters in that font name. The character string in the set of first name candidate data 43 is information specifying the name of a font acquired in S113. The set of second name candidate data 44 included in the piece of allocation information 40 also includes a character string of another font name and the number of characters in that font name. The character string in the set of second name candidate data 44 is also information specifying another name of the same font acquired in S113. The character string in the set of first name candidate data 43 is an example of a first font name. The character string in the set of second name candidate data 44 is an example of a second font name.

Returning to the description in FIG. 2 of the DL font saving process, in S126 the CPU 11 saves the piece of allocation information 40 created in S125 in the memory 12. The CPU 11 subsequently ends the DL font saving process. The series of processes of S125 and S126 is an example of a first creation process.

In S126 the CPU 11 saves the piece of allocation information 40 in the directory created in S121, for example, as a separate file from the glyph data file 30. In other words, the printer 1 creates one piece of allocation information 40 for each glyph data file 30. Subsequently, the printer 1 saves this piece of allocation information 40 created for the glyph data file 30 in the same directory as the glyph data file 30. Here, a different piece of allocation information 40 is stored in a different directory. That is, the directories to store the pieces of allocation information 40 have a one-to-one correspondence with the pieces of allocation information 40. In other words, the printer 1 saves the piece of allocation information 40 in the memory 12 in association with the corresponding glyph data file 30. In this way, the DL font saving process is unlikely to affect allocation information for other fonts already stored in the memory 12.

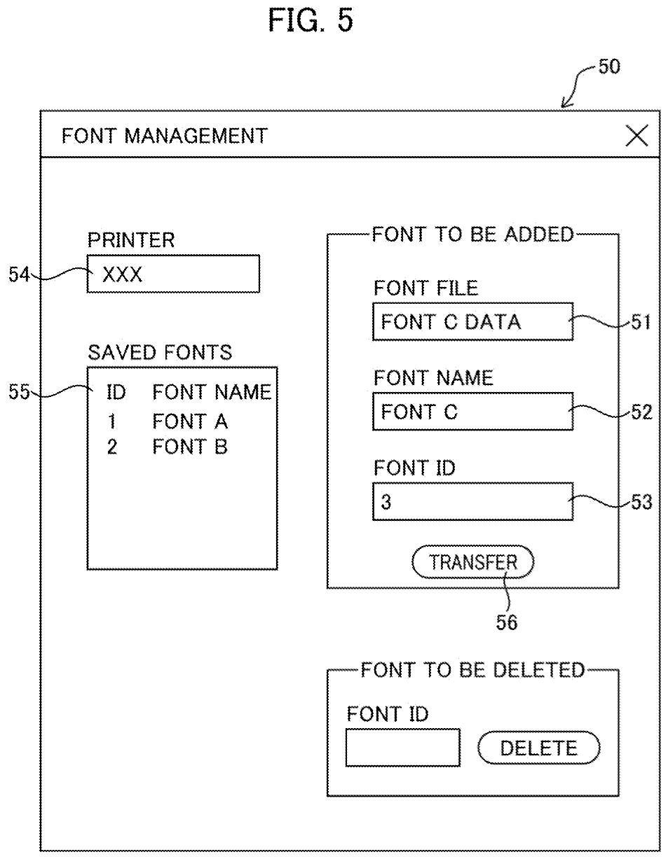

Next, the procedure performed on the PC 200 for transmitting a PJL command to the printer 1 instructing the printer 1 to save DL font information will be described. FIG. 5 shows an example of a font management screen 50. In response to user instructions, the font management program 201 provided in the PC 200 can display the font management screen 50 on a display (not shown) of the PC 200. A user of the printer 1 having administration privileges, for example, executes the font management program 201.

The font management screen 50 is a screen that accepts instructions to manage DL font information for a printer connected to the PC 200, for example. Through the font management screen 50, the font management program 201 can receive instructions to transfer the glyph data file 30 for a DL font stored in memory of the PC 200 to the printer 1.

In the font management screen 50, the PC 200 can receive input in a filename field 51, a font name field 52, and a font ID field 53 specifying a DL font to be transferred to a printer specified in a printer designation field 54. The filename field 51 receives inputted information for a filename specifying a glyph data file 30 for the DL font stored in the PC 200.

The font name field 52 receives input for a name (font name) used to manage an individual DL font on the PC 200. The font name inputted in the font name field 52 may be the same as or different from a font name included in the name table 31 of the glyph data file 30 (see FIG. 3). The font management program 201 on the PC 200 creates information specifying a destination path based on the font name inputted into the font name field 52, for example. The font ID field 53 receives input for a font ID to identify the font to be transferred.

The font management screen 50 also includes the printer designation field 54 that accepts the designation of a printer to be managed. In accordance with the font management program 201, the PC 200 communicates with the printer designated in the printer designation field 54 to acquire DL font information already saved on that printer. For example, when the printer designated in the printer designation field 54 is the printer 1, the font management program 201 displays fonts A and B as saved font information 55, as illustrated in FIG. 5. Note that the font management program 201 will not accept input in the font ID field 53 of a number (a value) identical to the font ID for a font included in the saved font information 55.

The font management screen 50 also includes a Transfer button 56. When the PC 200 receives an operation on the Transfer button 56, the PC 200 creates and transfers a PJL command in accordance with the font management program 201. Specifically, the PC 200 creates a PJL command that includes information specifying the destination path created based on the font name entered in the font name field 52, the font ID entered in the font ID field 53, and data for the file designated in the filename field 51. Subsequently, the PC 200 transmits the PJL command created above to the printer designated in the printer designation field 54 (e.g., the printer 1). Note that the font management program 201 may accept destination path information through the font management screen 50 instead of creating the destination path information based on the font name entered in the font name field 52.

The printer 1 executes the DL font saving process described above upon receiving a PJL command from the PC 200. As a result, the printer 1 receives data for the file specified in the filename field 51 and stores this data in the memory 12 as the glyph data file 30. The printer 1 also creates a piece of allocation information 40 corresponding to this glyph data file 30 and stores the piece of allocation information 40 in the memory 12.

The font management program 201 may also be capable of receiving instructions to delete font information displayed in the saved font information 55 of the font management screen 50 from the printer 1. When such a delete instruction is received, the font management program 201 creates a PJL command instructing the deletion and sends this command to the printer 1.

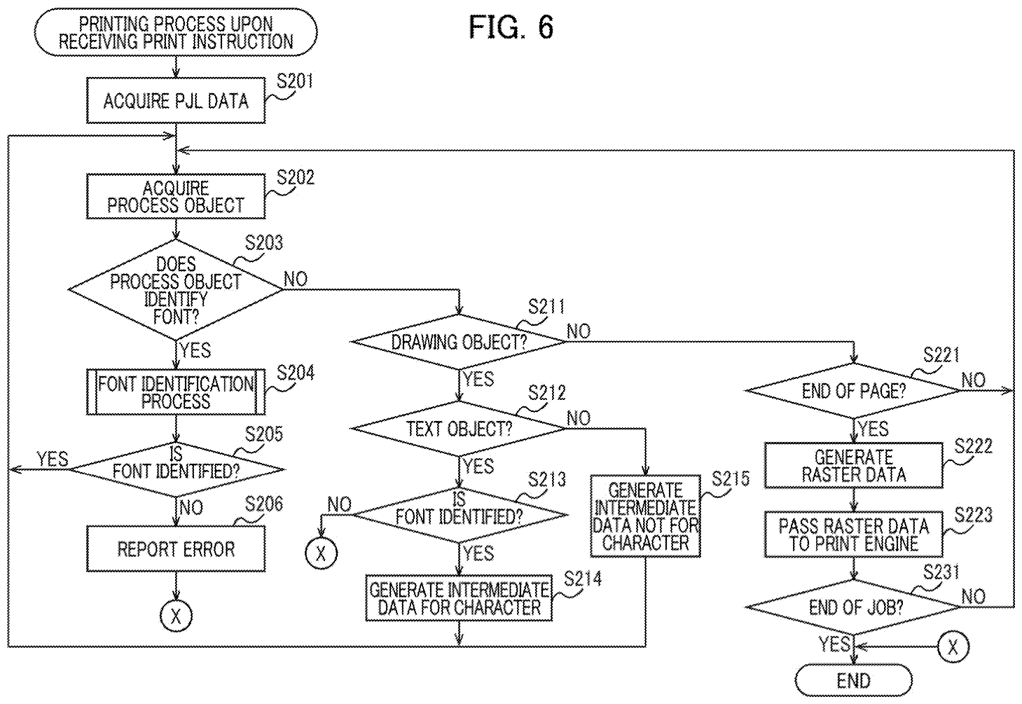

Next, steps in a printing process executed on the printer 1 will be described with reference to the flowchart in FIG. 6. The CPU 11 of the printer 1 executes this printing process in accordance with the print control program 21 upon receiving an instruction to execute a print job. The printer 1 may acquire a print job by receiving the print job from an external device via the communication IF 14 or by reading the print job from a USB memory mounted in the communication IF 14.

In S201 of FIG. 6, the CPU 11 extracts PJL data from the print job to be processed. The print job includes both PJL data and page description language (PDL) data. The PJL data specifies various printing-related parameters. The PDL data represents the image being to be printed. PDL data is described in a page description language of the format Printer Command Language (PCL) or Portable Document Format (PDF), for example.

The CPU 11 can identify the format of the PDL data on the basis of the PJL data. On the basis of the format of the PDL data, the CPU 11 can determine the type of information (for example, the font name or the font ID) needed to identify a glyph data file 30 for use in printing. Specifically, when the PDL data is in the PDF format, the CPU 11 identifies the glyph data file 30 on the basis of the font name. When the PDL data is the PCL 5 format, on the other hand, the CPU 11 identifies the glyph data file 30 using the font ID.

In S202 the CPU 11 acquires a process object in the PDL data included in the print data. The process object is a unit of data that the CPU 11 performs a process indicated therein. For example, the process object is a command, a text object, a drawing object, or an image object. The PDL data can include a plurality of process objects. In S203 the CPU 11 determines whether information for specifying (or identifying) the font of the character to be printed has been obtained from the acquired process object. For example, when a font dictionary is acquired from the acquired process object in the print data of the PDF format or when a font ID setting command or a font ID selection command is acquired from the acquired process object in the print data of the PCL 5 format, the CPU 11 determines that information for specifying a font is acquired. The process of S202 is an example of a first acquisition process.

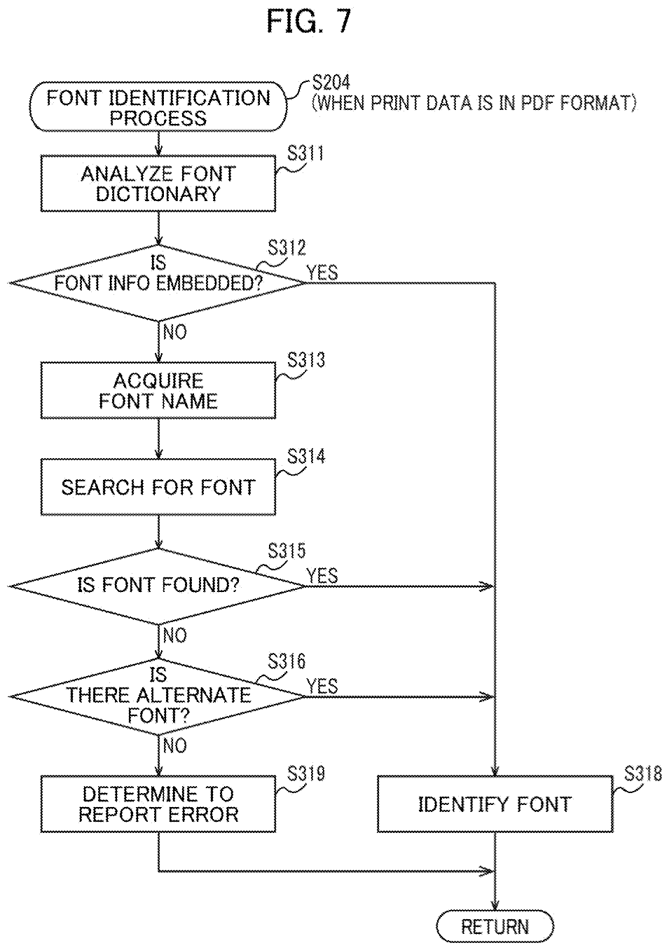

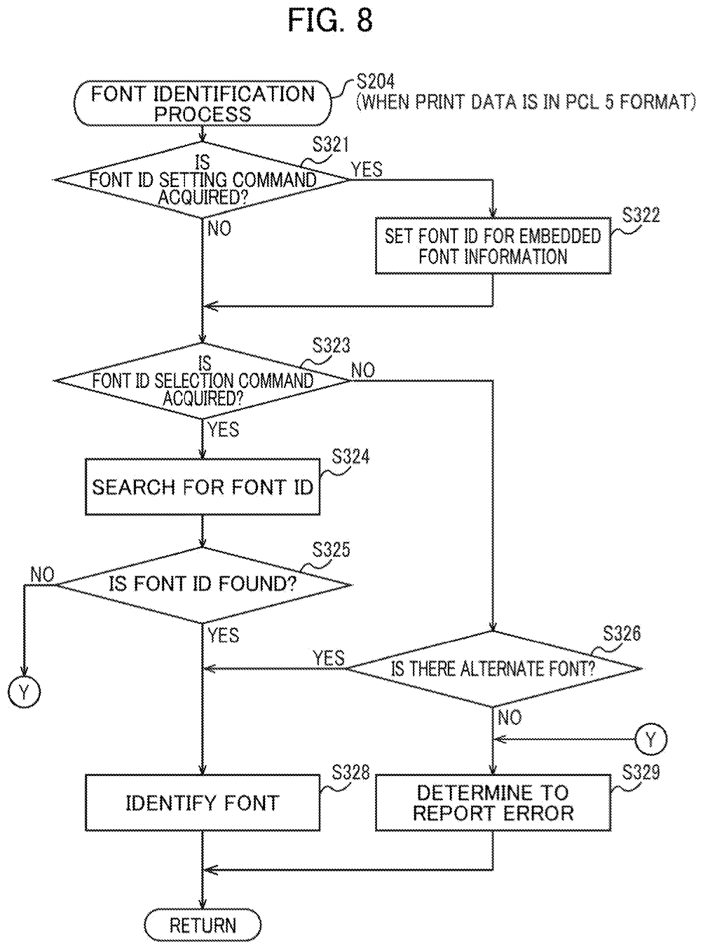

When the CPU 11 determines that information for specifying a font is acquired from the process object (S203: YES), in S204 the CPU 11 executes a font identification process. The font identification process is to identify a glyph data file 30, as font information, to be used when printing based on the print data, especially when drawing or rendering an image of the character in the print data. Steps in the font identification process will be described with reference to the flowcharts in FIGS. 7 and 8. The flowchart of FIG. 7 shows steps in the font identification process when the print data is in the PDF format. The flowchart of FIG. 8 shows steps in the font identification process when the print data is in the PCL 5 format. When the process object includes information for specifying a font, the process object may include a character code specifying a character to be rendered by the font (the font information) specified by the information for identifying the font.

In a case that the print data is in the PDF format, the CPU 11 determines in S203 that information for specifying the font is obtained when a font dictionary is acquired from that the acquired process object (S203: YES). In this case, the CPU 11 advances to S204 and executes the font identification process shown in FIG. 7.

In S311 of the font identification process in FIG. 7, the CPU 11 begins analyzing the font dictionary. In S312 the CPU 11 then determines whether font information for the font to be used for printing is embedded in the font dictionary.

When the CPU 11 determines that font information is embedded in the font dictionary (S312: YES), in S318 the CPU 11 identifies the font represented by this embedded font information as the font to be used for printing. Next, the CPU 11 reads the font information from the font dictionary. In this case, the CPU 11 will acquire one or more sets of glyph data in a subsequent procedure using the font information read from the font dictionary.

However, when the CPU 11 determines that font information is not embedded in the dictionary (S312: NO), in S313 the CPU 11 acquires information of the font name specifying the font from the font dictionary. The process of S313 is an example of a second acquisition process.

In S314 the CPU 11 searches all name candidates contained in all pieces of allocation information (222 and 232 in this example) stored in the memory 12 for the font name acquired in S313. Specifically, the CPU 11 sequentially reads each name candidate contained in each piece of allocation information 222 and 232, and checks whether the name candidate matches the font name acquired in S313, which is the subject or target of the search. In this example, when the CPU 11 determines that the character string of the name candidate contains the character string of the font name of the target of the search, the CPU 11 determines that the name candidate matches the font name of the target of the search. In other words, the CPU 11 determines that names match even when the character strings of the names match partially. However, the CPU 11 may determine that name candidate matches the font name acquired in S313 only when these names perfectly match.

In S315 the CPU 11 determines whether any of the character strings of name candidates in the pieces of allocation information 222 and 232 stored in the memory 12 contains a character string of the font name targeted in the search. When the CPU 11 determines that there is a name candidate whose character string contains that of the font name of the target (S315: YES), in S318 the CPU 11 identifies the glyph data file 30 associated with the piece of allocation information 40 containing the matching font name and identifies this glyph data file 30 as the information to be used for printing (font information).

Specifically, the CPU 11 identifies the glyph data file 30 stored in the same directory as the piece of allocation information 40 having the matching font name as the information to be used for printing. In a subsequent procedure, the CPU 11 acquires one or more sets of glyph data from the glyph data file 30 identified in S318. The process of S318 in this case is an example of a specific process.

In a case that the piece of allocation information 40 includes a plurality of character strings of a plurality of name candidates, the CPU 11 determines that a name candidate in the piece of allocation information 40 matches the font name targeted in the search when any one of the font names in the piece of allocation information 40 matches the font name targeted in the search. For example, in a case that the piece of allocation information 40 stores two sets of name candidate data 43 and 44, as in the case of FIG. 4, the CPU 11 determines that the font name in the piece of allocation information 40 matches the font name of the search target regardless of whether the font name of the search target matches the first name candidate data 43 or the second name candidate data 44. When a single glyph data file 30 contains a plurality of names, the piece of allocation information 40 also contains the plurality of names. Therefore, the CPU 11 can identify the same glyph data file 30 regardless of which filename has been specified in the font name acquired in S313.

Thus, the printer 1 identifies the glyph data file 30 by acquiring the font name included in the print data and searching the pieces of allocation information 40 for that font name. This process enables the printer 1 to identify the glyph data file 30 more quickly than a conceivable case in which the printer 1 reads each glyph data file 30, extracts the font names from each glyph data file 30, and sequentially searches those font names.

When the CPU 11 determines that none of the character strings of name candidates in the pieces of allocation information 222 and 232 contain the character string of the font name targeted in the search (the subject of the search) (S315: NO), in S316 the CPU 11 determines whether there is an alternate font to use in place of the font specified by the font name targeted in the search (that is, determines whether the alternate font is available). An alternate font in this case is a font that can be used for print data in the PDF format. For example, the printer 1 may have font information for one of the built-in fonts that can be used for print data in the PDF format.

When the CPU 11 determines that an alternate font is available (S316: YES), in S318 the CPU 11 identifies this alternate font as the font to be used in printing. In this case, the CPU 11 acquires one or more sets of glyph data in a subsequent procedure from the font information for the alternate font.

However, when font information is not embedded in the font dictionary, there is no piece of allocation information including a matching font name, and no alternate font is available (S316: NO), in S319 the CPU 11 determines that an error should be reported because appropriate font information is not available. In this case, the CPU 11 makes a judgment to issue an error because font information cannot be obtained and the character cannot be printed appropriately.

After completing the process in S318 or S319, the CPU 11 ends the font identification process and returns to the printing process of FIG. 6.

On the other hand, in a case that the print data is in the PDL 5 format, and the CPU 11 obtains a font ID setting command or a font ID selection command from the acquired process object, the CPU 11 determines that information for specifying the font is acquired (S203: YES). In this case, the CPU 11 advances to S204 and executes the font identification process shown in FIG. 8.

In S321 of the font identification process in FIG. 8, the CPU 11 determines whether a font ID setting command has been acquired in S203 of the printing process. The font ID setting command is information for setting a font ID for an embedded font when font information for that font is embedded in the print data. In other words, when the font ID setting command has been acquired, there is a high probability that font information for the font to be used is embedded in the print data.

When the CPU 11 determines that a font ID setting command has been acquired (S321: YES), in S322 the CPU 11 acquires font information embedded in the print data and sets the font ID for this font information to the font ID specified in the font ID setting command.

Following the process of S322 or when the CPU 11 determines that a font ID setting command has not been acquired (S321: NO), in S323 the CPU 11 determines whether a font ID selection command has been acquired. A font ID selection command contains a font ID and an instruction that the font indicated by this font ID is to be used for printing. The font ID included in the font ID selection command is an example of specific information. The process of S323 is an example of a second acquisition process. When the process of S323 is performed by way of the process of S322, the currently acquired process object may not include the font ID selection command, but another process object may include the font ID selection command. In order to address such a situation, when the process of S323 is performed by way of the process of S322 and the currently acquired process object does not include the font ID selection command, in S323 the CPU 11 may search the print data for the font ID selection command of the font ID that is the same as the font ID set in S322. In this case, when the font ID selection command is found, the CPU 11 determines that the font ID selection command has been acquired (S323: YES).

When the CPU 11 determines that a font ID selection command has been acquired (S323: YES), in S324 the CPU 11 searches a group of font IDs for the font ID specified in the font ID selection command. Here, the group of font IDs that the CPU 11 searches includes: the font IDs included in all pieces of allocation information 222 and 232 stored in the memory 12; and the font ID that has been set in S322 when the print data includes a font ID setting command. Specifically, the CPU 11 sequentially reads font IDs contained in all pieces of allocation information 222 and 232 and checks whether the font ID matches the font ID acquired in S323, which is the subject of the font ID search. When the print data includes a font ID setting command, the CPU 11 checks whether the font ID set in S322 matches the font ID acquired in S323.

In S325 the CPU 11 then determines whether the font ID that is the subject of the search exists in the group of the font IDs. When the CPU 11 determines that the font ID exists (S325: YES), in S328 the CPU 11 identifies (or sets) the font identified by the font ID as a font to be used for printing.

Specifically, when the font ID targeted in the search matches a font ID included in the piece of allocation information 40, the CPU 11 identifies the glyph data file 30 stored in the same directory as that piece of allocation information 40 as the information (font information) to be used for printing. The process of S328 in this case is an example of the specific process. Further, when the font ID that is the subject of the search matches the font ID set in S322, the CPU 11 identifies the font information acquired in S322 as the information to be used for printing. In a subsequent procedure, the CPU 11 acquires one or more sets of glyph data from the font information identified in S328.

Thus, the printer 1 identifies the glyph data file 30 by acquiring a font ID from the font ID selection command in the acquired process object and searching the pieces of allocation information 40 for that font ID. This enables the printer 1 to easily identify the glyph data file 30 associated with the font ID specified in print data, even when the font itself is not embedded in the print data but only a font ID is set therein.

On the other hand, when the CPU 11 determines that no font ID selection command has been acquired (S323: NO), in S326 the CPU 11 determines whether an alternate font is available (that is, determines whether there is the alternate font). In this case, an alternate font is a font that can be used in print data of the PCL 5 format. For example, the printer 1 may be provided with font information as one of the built-in fonts that can be used in print data of the PCL 5 format.

When an alternate font is available (S326: YES), in S328 the CPU 11 identifies this alternate font as the font to be used in printing. In this case, the CPU 11 acquires one or more sets of glyph data in a subsequent procedure from the font information for the alternate font.

When the CPU 11 determines that no font ID in the group of font IDs matches the font ID subject to the search in S324 (S325: NO) or when there are no alternate fonts (S326: NO), in S329 the CPU 11 determines that an error should be reported because there is not information on an appropriate font. In this case, the CPU 11 makes the determination to issue an error because font information cannot be acquired and characters cannot be printed appropriately.

After completing the process in S328 or S329, the CPU 11 ends the font identification process and returns to the printing process in FIG. 6.

Returning to the description in FIG. 6 of the printing process, in S205 after the font identification process of S204 the CPU 11 determines whether a font is identified in the process of S204. In the font identification process of S204 the CPU 11 has searched for a font based on the font name when the print data is in the PDF format, or has searched for a font based on the font ID when the print data is in the PCL 5 format. Because information for both the font name and font ID is stored in each piece of allocation information 40 and the piece of allocation information 40 is associated with a single glyph data file 30, the glyph data file 30 can be easily identified irrespective of the print data format.

When the CPU 11 determines that a font (font information) is identified, i.e., that the glyph data to be used for printing, such as a glyph data file 30 or glyph data of an embedded font, is identified (S205: YES), the CPU 11 returns to S202 to acquire a next print object.

However, when the CPU 11 determines that the font is not identified, and determines to report an error (S205: NO), in S206 the CPU 11 reports an error and subsequently ends the printing process. The CPU 11 reaches a NO determination in S205 when a determination to report an error is made in S319 or S329 of the font identification process.

Further, when the CPU 11 determines in S203 that information for specifying the type of font is not acquired from the acquired process object (S203: NO), in S211 the CPU 11 determines whether a drawing object is acquired from the process object acquired in S202. When the CPU 11 determines that a drawing object has been acquired (S211: YES), in S212 the CPU 11 determines whether the acquired drawing object is a text object specifying the drawing of a character.

When the CPU 11 determines that a text object has been acquired (S212: YES), in S213 the CPU 11 determines whether the font (font information) to be used for drawing the character has already been identified. Here, the CPU 11 determines whether the font identification process in S204 has been previously executed and whether the font information has been identified in that font identification process.

When the CPU 11 determines that the font has already been identified (S213: YES), in S214 the CPU 11 generates intermediate data for the character using font information of the identified font. The print data may be configured that process objects specifying the same font is arranged continuously without a draw object therebetween. In such a case, by repeating the process of S202 the CPU 11 continuously acquires the continuously-arranged process objects specifying the same font, and thus does not acquire the draw object therebetween. In other words, after all the continuously-arranged process objects specifying the same font are acquired, the CPU 11 acquires the draw object to draw characters specified in the previously-acquired process objects. In this case, the intermediate data for these characters is generated at a time in one process of S214. Specifically, when a glyph data file 30 has been identified, the CPU 11 acquires the set of glyph data corresponding to the character code specified in the print data from this glyph data file 30 and generates intermediate data for the character using the acquired set of glyph data. The process of S214 is an example of a drawing process.

On the other hand, when the CPU 11 determines in S212 that the acquired drawing object is not a text object (S212: NO), in S215 the CPU 11 generates intermediate data for an object other than characters based on the drawing object. After completing the process in S214 or S215, the CPU 11 returns to S202 and acquires a next process object.

Further, when the CPU 11 determines in S213 that a font has not been identified despite acquiring a text object (S213: NO), the CPU 11 ends the printing process. The CPU 11 may also report an error in this case.

Further, when the CPU 11 determines that neither information for specifying a font nor a drawing object is acquired (S211: NO), in S221 the CPU 11 determines whether an end-of-page command indicating the end of the page is acquired from the acquired process object. When the CPU 11 determines that an end-of-page command is not acquired (S221: NO), the CPU 11 returns to S202 and acquires a next process object.

When the CPU 11 determines that the end-of-page command is acquired (S221: YES), in S222 the CPU 11 generates raster data for one page using the generated intermediate data. In S223 the CPU 11 further passes the generated raster data to the print engine 15. The print engine 15 performs printing for one page based on the received raster data.

In S231 the CPU 11 determines whether an end-of-job command is acquired from the acquired process object. When the CPU 11 determines that the acquired process object includes no end-of-job command (S231: NO), the CPU 11 returns to S202 to acquire a process object for a next page from the print data. When the CPU 11 determines that the end-of-job command is acquired (S231: YES), the CPU 11 ends the printing process.

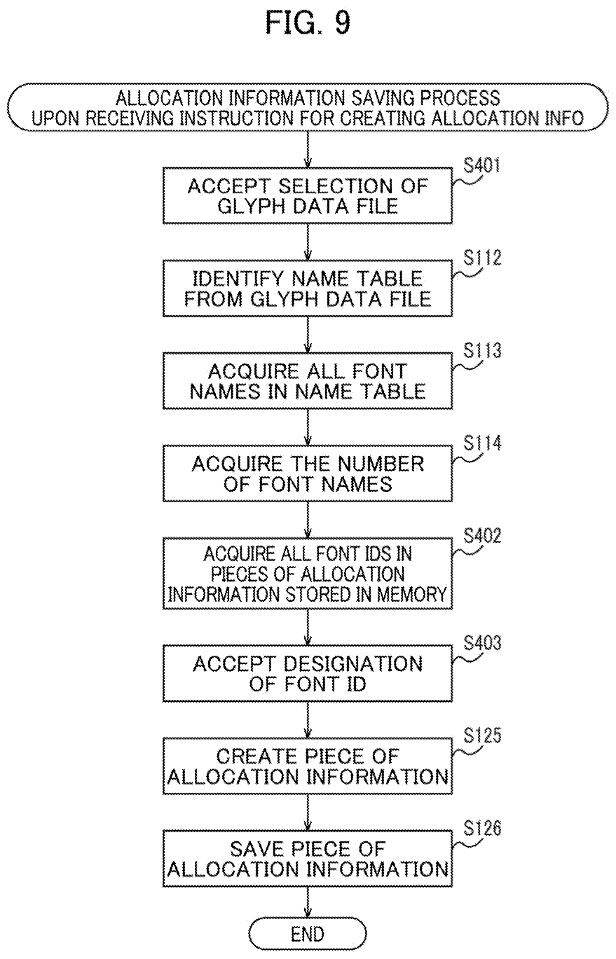

Next, steps in a process for saving allocation information will be described with reference to the flowchart in FIG. 9. The CPU 11 of the printer 1 executes the allocation information saving process upon receiving an instruction via the user IF 13 or communication IF 14 to create a piece of allocation information 40 corresponding to a glyph data file 30 stored in the memory 12. In FIG. 9 and the following description, steps identical to those in the DL font saving process of FIG. 2 are designated with the same step numbers to simplify the description.

Rather than receiving a PJL command sent from the PC 200, the printer 1 may also obtain only a glyph data file 30 from an external device. For example, the printer 1 can acquire the glyph data file 30 by reading the glyph data file 30 from a USB memory mounted in the communication IF 14 or by downloading the glyph data file 30 from the server 100 via the communication IF 14. Once the glyph data file 30 obtained from the external device has been stored in the memory 12, the printer 1 can then accept an instruction to create a piece of allocation information 40 corresponding to that glyph data file 30. An application program such as the font management program 201 may transmit an instruction to create the piece of allocation information 40 as a PJL command.

In S401 of the allocation information saving process, the CPU 11 accepts the selection of a glyph data file 30 for which a piece of allocation information 40 is to be created from among glyph data files 30 stored in the memory 12. The CPU 11 may report an error when a piece of allocation information 40 associated with the glyph data file 30 selected in S401 has already been created. The process of S401 is an example of a selection process.

In S112 the CPU 11 identifies the name table 31 in the selected glyph data file 30 and in S113 obtains all names included in the name table 31. In S114 the CPU 11 determines the number of acquired names. The process of S113 in this case is an example of the second reading process. In S402 the CPU 11 acquires all font IDs included in the pieces of allocation

information 40 corresponding to other glyph data files 30 stored in the memory 12. In S403 the CPU 11 accepts the designation of a font ID via the user IF 13, for example, to be included in the piece of allocation information 40 being created. In S403 the CPU 11 does not accept the font ID the same as one of the font IDs that have been acquired in S402. The CPU 11 may also transmit information on the font ID set in S403 to the PC 200 connected to the printer 1 to share with the font management program 201 or other application program. The process of S403 is an example of a second determination process.

Rather than accepting a user designation of a font ID, in S403 the CPU 11 may automatically set a font ID different from any of the font IDs obtained in S402. In this case, the CPU 11 may report via the user IF 13 what font ID is set.

In S125 the CPU 11 creates a piece of allocation information 40 corresponding to the selected glyph data file 30. In S126 the CPU 11 saves the piece of allocation information 40 created in S125 in the memory 12 and subsequently ends the allocation information saving process. The series of processes of S125 and S126 is an example of a second creating process.

Because the printer 1 can accept an instruction to create a piece of allocation information 40, the printer 1 can download and store glyph data files 30 in the memory 12 after being shipped from the factory, for example, and can subsequently create pieces of allocation information 40 corresponding to these glyph data files 30. However, creating and saving a piece of allocation information 40 through the DL font saving process shown in FIG. 2 when a glyph data file 30 is acquired facilitates the printer 1 in using the glyph data file 30 immediately for printing.

The PC 200 may create the piece of allocation information 40 corresponding to the glyph data file 30 in advance and may send the glyph data file 30 and the piece of allocation information 40 corresponding to that glyph data file 30 to the printer 1. When the printer 1 receives the glyph data file 30 and the piece of allocation information 40, the printer 1 may store them in the same directory.

As described in detail above, the printer 1 of the embodiment stores pieces of allocation information 40, each including font names and a font ID and being in association with the glyph data files 30. The printer 1 searches the pieces of allocation information 40 for a font name or font ID acquired in print data. Hence, by referencing the pieces of allocation information 40, the printer 1 can easily identify the glyph data file 30 associated with a font name or font ID acquired from print data through the piece of allocation information 40 and can draw text using the identified glyph data file 30. This method can suppress processing delays during printing executed by the printer 1.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

For example, the printer 1 may not be a device having only the printing function and may be any device having a different function in addition to a printing function, such as a multifunction peripheral, a copying machine, and a facsimile device.

The configurations of the glyph data file 30 shown in FIG. 3 and the piece of allocation information 40 shown in FIG. 4 are merely examples and are not limited to these configurations. For example, the glyph data file 30 may include additional information. The piece of allocation information 40 may also be included in the glyph data file 30. However, because the glyph data file 30 is a large file, storing the piece of allocation information 40 as a separate file from the glyph data file 30 avoids the need to open the glyph data file 30 for each search, thereby simplifying and speeding up the search process.

In the above embodiment, the printer 1 creates a directory for each DL font and saves the glyph data file 30 and the piece of allocation information 40 for that font in the corresponding directory, but the present invention is not limited to this configuration. For example, the printer 1 may save a plurality of pieces of allocation information 40 for all DL fonts in a single directory separate from the glyph data files 30. Alternatively, the printer 1 may save a plurality of pieces of allocation information 40 for all DL fonts in a single file. In such cases, the printer 1 stores association information associating each piece of the allocation information 40 with a respective one of the glyph data files 30.

Each piece of allocation information may include association information specifying a glyph data file 30 so that the piece of allocation information is associated with the glyph data file 30. Alternatively, each piece of allocation information may include information so as to associate each of a font ID therein and one or more name candidates therein with a corresponding glyph data file 30.

The printer 1 may also be provided with programs and data for implementing the functions of an embedded web server (hereinafter “EWS”). For example, the printer 1 may be configured to accept instructions for saving DL font information or instructions for creating allocation information via the EWS instead of in PJL commands.

In the above embodiment, a single font ID is set for each glyph data file 30, but the printer 1 may be configured to set a plurality of different font IDs for a single glyph data file 30. In this case, the plurality of font IDs are stored in the piece of allocation information 40 corresponding to the single glyph data file 30.

In the above embodiment, the printer 1 searches allocation information 40 for information matching the font name or font ID included in the print data but the information need not match exactly, provided that there is a one-on-one correspondence. For example, allocation information 40 may include, as name candidate data, a character string including a plurality of name candidates. In this case, the character string including a plurality of name candidates may be delineated by symbols such as parentheses. For example, a character string “(font name A)(font name B)” may indicate two name candidates of “font name A” and “font name B”. Alternatively, allocation information 40 may include, as name candidate data, a character string including a plurality of name candidates. In this case, the character string may be delineated by characters, such as a slash marks “/”, underscores “_” and hyphens “-”. For example, a character string “font name A/font name B” may indicate two name candidates of “font name A” and “font name B”. In these cases, the information for the number of characters in the name candidate need not be included in the piece of allocation information 40. Further, in these cases, when the character string, as name candidate data in the piece of allocation information, includes the font name in the print data, in S315 the CPU 11 may determine that the character string in the piece of allocation information match the font name in the print data. For example, when the name candidate data in the piece of allocation information 40 is the character string “(font name A)(font name B)” and the font name is “font A”, the character string “(font name A)(font name B)” includes “font A”, the CPU 11 reaches YES determination in S315.

In any of the flowcharts disclosed in the embodiment, the plurality of processes that makes up any of a plurality of steps may be executed in parallel, or the order in which the processes are performed may be modified in any way that does not produce any inconsistencies in the processes.

The processes disclosed in the embodiment may be performed by a single CPU, a plurality of CPUs, hardware such as one or more application specific integrated circuits (ASICs) or any combination of these. The processes disclosed in the embodiment may be implemented through various manners, such as a recording medium storing program instructions for the processes, or a method defining the processes.

What is claimed is:

1. A printer comprising:
a memory;
a print engine; and
a controller configured to perform:
a first acquisition process to acquire print data specifying a character;
a second acquisition process to acquire specific information from the print data, the specific information specifying a font;
an identification process to identify a target font file, using the piece of allocation information stored in the memory, from among the plurality of font files, the piece of allocation information being for associating the specific information with the target font file, the identification process being to reference the piece of allocation information to identify the target font file associated with the specific information acquired in the second acquisition process; and
a drawing process to draw an image of the character using the target font file to generate image data to be used in printing by the print engine.

2. The printer according to claim 1, wherein the identification process performs:
searching the piece of allocation information for the specific information; and
when the specific information is found in the piece of allocation information as a result of the searching the piece of allocation information for the specific information, identifying the target font file associated with the specific information found as the result of the searching the piece of allocation information for the specific information.

3. The printer according to claim 1, wherein the second acquisition process acquires, as the specific information, a specific font name included in the print data, the specific font name being a name of the font,
wherein the piece of allocation information is for associating the specific font name with the target font file,
wherein the identification process identifies the target font file associated with the specific font name by referencing the piece of allocation information.

4. The printer according to claim 3, wherein the target font file includes first-font name information on a first font name and second-font name information on a second font name,
wherein the piece of allocation information is for associating each of the first font name and the second font name with the target font file,
wherein the identification process performs:
determining whether a character string of one of the first font name and the second font name includes a character string of the specific font name; and
when the character string of the one of the first font name and the second font name includes the character string of the specific font name, identifying the target font file associated with each of the first font name and the second font name by referencing the piece of allocation information.

5. The printer according to claim 1, wherein the second acquisition process acquires, as the specific information, a specific font identifier included in the print data, the specific font identifier identifying the font,
wherein the piece of allocation information is for associating the specific font identifier with the target font file,
wherein the identification process identifies the target font file associated with the specific font identifier acquired in the second acquisition process by referencing the piece of allocation information.

6. The printer according to claim 1, wherein the second acquisition process acquires, as the specific information, one of a specific font name and a specific font identifier included in the print data, the specific font name being a name of the font, the specific font identifier identifying the font,
wherein the piece of allocation information is for associating each of the specific font name and the specific font identifier with the target font file,
wherein the identification process identifies the target font file associated with the one of the specific font name and the specific font identifier acquired in the second acquisition process by referencing the piece of allocation information.

7. The printer according to claim 1, wherein the identification process identifies the target font file by searching a plurality of pieces of allocation information stored in the memory for the specific information acquired in the second acquisition process, each of the plurality of pieces of allocation information being for associating specific information, which specifies a respective one of a plurality of fonts, with a respective one of a plurality of font files, the plurality of pieces of allocation information including the piece of allocation information.

8. The printer according to claim 1, wherein the controller is configured to further perform:
a storing process to store the target font file including font-name information on a font name in the memory;
a reading process to read the font-name information from the target font file;
a setting process to set a font identifier for the target font file stored in the memory;
a creating process to create the piece of allocation information, the piece of allocation information being for associating the font name of the font-name information read in the reading process with the target font file and further being for associating the font identifier set in the setting process with the target font file; and
a saving process to save the piece of allocation information created in the creating process in the memory.

9. The printer according to claim 8, wherein the storing process performs receiving the target font file and storing the target font file in the memory,
wherein the reading process, the setting process, the creating process, and the saving process are performed in response to the target font file being received in the storing process.

10. The printer according to claim 1, wherein the controller is configured to further perform:
a selection process to receive a selection operation to select a font file, as a selected font file, from among the plurality of font files in the memory;
a reading process to read font-name information from the selected font file, the font-name information indicating a font name;
a setting process to set a font identifier for the selected font file;
a creating process to create a piece of allocation information that: is for associating the font name indicated in the font-name information read in the reading process with the selected font file; and further is for associating the font identifier set in the setting process with the selected font file; and
a saving process to save the piece of allocation information created in the creating process in the memory.
